(19) United States
(12) Patent Application Publication
(10) Pub. No.: US 2025/0370288 A1
(43) Pub. Date: Dec. 4, 2025

(54) DISPLAY DEVICE

(71) Applicant: Japan Display Inc., Tokyo (JP)

(72) Inventors: Hirofumi OHIRA, Tokyo (JP); Koji YOSHIDA, Tokyo (JP)

(73) Assignee: Japan Display Inc., Tokyo (JP)

(21) Appl. No.: 19/214,118

(22) Filed: May 21, 2025

(30) Foreign Application Priority Data
May 28, 2024 (JP) 2024-086116

(51) Int. Cl. G02F 1/13; G02F 1/1343; G02F 1/1347

(52) U.S. Cl. CPC G02F 1/1323; G02F 1/134309; G02F 1/1347

(57) ABSTRACT

According to an aspect, a display device includes: a liquid crystal display panel including a display region in which pixels are arranged, an electro-optical device, and a control circuit. The electro-optical device includes a first substrate including a first electrode, a second substrate including a second electrode, and a liquid crystal layer. The control circuit is configured to operate the electro-optical device in one of a first mode in which a potential difference between the first and second electrodes is set to be zero and a second mode in which the potential difference between the first and second electrodes is set to be larger than zero. In a case where the liquid crystal display panel displays achromatic white in the pixels, chromaticity of the pixels when the electro-optical device operates in the first mode is equal to that when the electro-optical device operates in the second mode.

### CROSS-REFERENCE TO RELATED APPLICATION

This application claims the benefit of priority from Japanese Patent Application No. 2024-086116 filed on May 28, 2024, the entire contents of which are incorporated herein by reference.

### BACKGROUND

### 1. Technical Field

What is disclosed herein relates to a display device.

### 2. Description of the Related Art

Japanese Patent Application Laid-open Publication No. 2006-195388 (JP-A-2006-195388) discloses, as an example of a display device, a display system including a viewing angle control panel that includes a liquid crystal layer including a twisted nematic liquid crystal element (liquid crystal molecules) and controls the viewing angle of a display surface. The display system of JP-A-2006-195388 is mounted, for example, on a vehicle. The viewing angle control panel (example of an electro-optical device) controls the viewing angle of a display region as the liquid crystal molecules operate. This switches between a visible state in which a person on the driver seat can visually recognize an image and a non-visible state in which the person on the driver seat cannot visually recognize the image. In both the visible state and non-visible state of the display system, a person on the front passenger seat can visually recognize the image.

However, the hue of an image visually recognized by a person on the front passenger seat potentially differs due to the operation of liquid crystal molecules in the viewing angle control panel between the visible state and the non-visible state.

For the foregoing reasons, there is a need for reducing the difference in hue before and after a change in the viewing angle in a display device capable of changing the viewing angle.

### SUMMARY

According to an aspect, a display device includes: a liquid crystal display panel including a display region in which pixels are arranged; an electro-optical device overlapping the liquid crystal display panel in plan view; and a control circuit. The electro-optical device includes a first substrate including a first electrode, a second substrate including a second electrode facing the first electrode, and a liquid crystal layer positioned between the first electrode and the second electrode. The control circuit is configured to operate the electro-optical device in one of a first mode in which a potential difference between the first electrode and the second electrode is set to be zero and a second mode in which the potential difference between the first electrode and the second electrode is set to be larger than zero. In a case where the liquid crystal display panel displays achromatic white in the pixels, chromaticity of the pixels when the electro-optical device operates in the first mode is equal to chromaticity of the pixels when the electro-optical device operates in the second mode.

### BRIEF DESCRIPTION OF THE DRAWINGS

FIG. 1 is a plan view of a display device according to an embodiment of the present disclosure;

FIG. 2 is a side view of the display device;

FIG. 3 is a diagram illustrating a circuit configuration of a liquid crystal display panel;

FIG. 4 is a sectional view of the liquid crystal display panel and a viewing angle control panel;

FIG. 5 is a plan view of the viewing angle control panel;

FIG. 6 is a diagram illustrating the chromaticity of a pixel in an xy chromaticity diagram of the CIE 1931 color space;

FIG. 7 is a diagram illustrating the relation between the gradation value and luminance of a sub pixel; and

FIG. 8 is a diagram illustrating the correlation between the gradation value of a sub pixel and the voltage applied to the sub pixel.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate.

What is disclosed herein is only an example, and any modifications that can be easily conceived by those skilled in the art while maintaining the main purpose of the disclosure are naturally included in the scope of the present disclosure. The drawings may be schematically represented in terms of the width, thickness, shape, etc. of each part compared to those in the actual form for the purpose of clearer explanation, but they are only examples and do not limit the interpretation of the present disclosure. In the present specification and the drawings, the same reference sign is applied to the same elements as those already described for the previously mentioned drawings, and detailed explanations may be omitted as appropriate.

A D1 direction and a D2 direction illustrated in the drawings correspond to directions orthogonal to each other and parallel to a principal surface (for example, front surface) of a substrate included in a display device 1. A positive D1 side (side indicated by an arrow) and a negative D1 side (side opposite to the positive D1 side) in the D1 direction and a positive D2 side (side indicated by an arrow) and a negative D2 side (side opposite to the positive D2 side) in the D2 direction correspond to sides of the display device 1. A D3 direction corresponds to a direction orthogonal to the principal surface of the substrate included in the display device 1, a positive D3side (side indicated by an arrow) in the D3 direction corresponds to a front surface side on which an image is displayed in the display device 1, and a negative D3 side (side opposite to the positive D3 side) in the D3 direction corresponds to a back surface side of the display device 1. In the present specification, “plan view” is a view when the display device 1 is viewed in the D3 direction from one of the positive D3 side and the negative D3 side. The D1, D2, and D3 directions are exemplary, and the present disclosure is not limited to these directions.

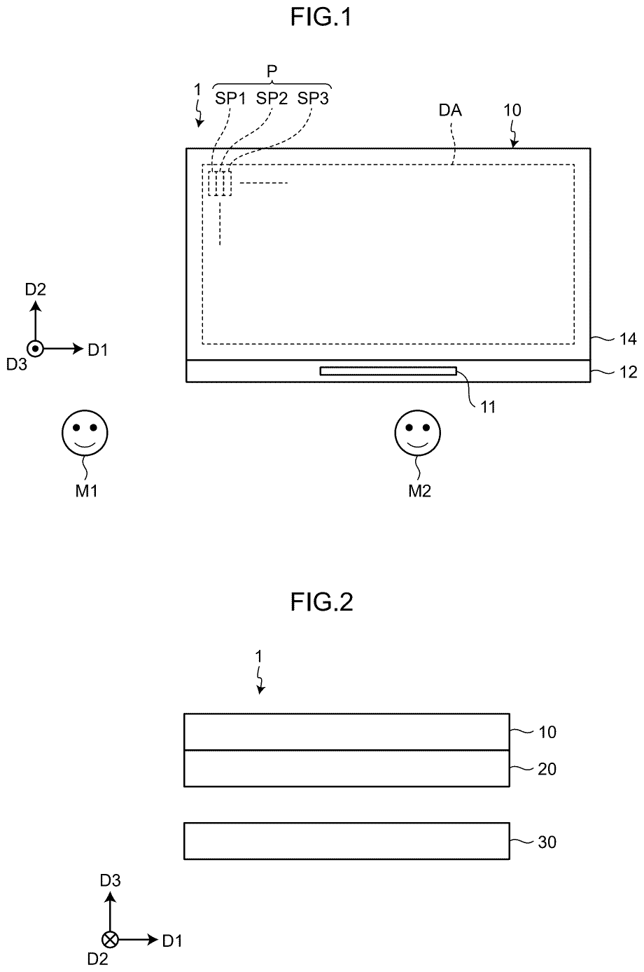

FIG. 1 is a plan view of the display device 1 according to the embodiment of the present disclosure. A rectangular display region DA in which an image is displayed is provided at the front surface of the display device 1.

The display device 1 is mounted on, for example, a vehicle and attached at a position where a person M1 on the driver seat and a person M2 on the front passenger seat can view the display region DA of the display device 1. The person M1 on the driver seat is positioned on the negative D1 side of the display device 1. The person M2 on the front passenger seat is positioned at a position facing the display device 1 in the D3 direction, specifically, in front of the display device 1. The positions of the persons M1 and M2 relative to the display device 1 are not limited to the above-described positions.

FIG. 2 is a side view of the display device 1. The display device 1 includes a liquid crystal display panel 10, a viewing angle control panel 20 that is an electro-optical device, and a backlight unit 30. The liquid crystal display panel 10, the viewing angle control panel 20, and the backlight unit 30 are disposed in the stated order from the positive D3 side toward the negative D3 side. The liquid crystal display panel 10 and the viewing angle control panel 20 are bonded to each other.

The liquid crystal display panel 10 is a transmissive liquid crystal display. The liquid crystal display panel 10 may be, for example, an organic EL display or an inorganic EL display. The front surface of the liquid crystal display panel 10 corresponds to the front surface of the display device 1 and includes the display region DA. As illustrated in FIG. 1, the liquid crystal display panel 10 includes a plurality of pixels P disposed in a matrix having a row-column configuration in the D1 and D2 directions in the display region DA.

Each pixel P includes a first sub pixel SP1, a second sub pixel SP2, and a third sub pixel SP3. The first sub pixel SP1 is a red sub pixel. The second sub pixel SP2 is a green sub pixel. The third sub pixel SP3 is a blue sub pixel. The first sub pixel SP1, the second sub pixel SP2, and the third sub pixel SP3 are arranged in the stated order in the D1 direction. The array of the first sub pixel SP1, the second sub pixel SP2, and the third sub pixel SP3 is what is called a stripe array. Hereinafter, the first sub pixel SP1, the second sub pixel SP2, and the third sub pixel SP3 are also simply referred to as “sub pixels SP” when they are described without being distinguished. The array of sub pixels SP is not limited to the stripe array, and the number of sub pixels SP and the colors of the sub pixels SP are not limited to the above-described number and colors.

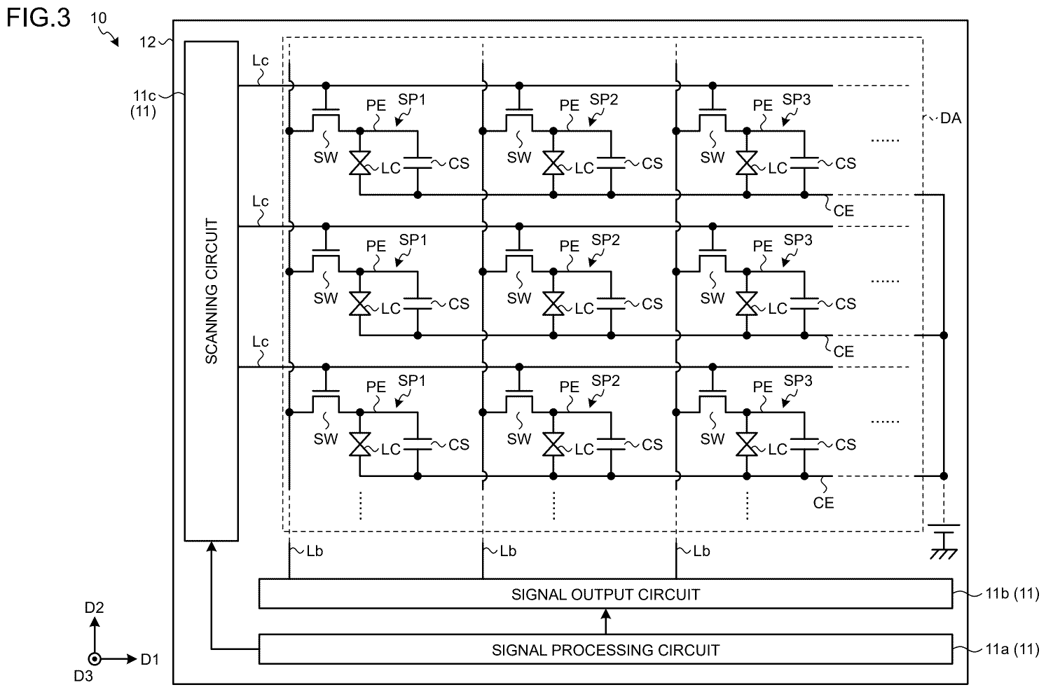

FIG. 3 is a diagram illustrating a circuit configuration of the liquid crystal display panel 10. The liquid crystal display panel 10 includes a first control circuit 11, and also includes a switching element SW, a sub pixel electrode PE, a common electrode CE, a liquid crystal capacitor LC, and a storage capacitor CS provided in each sub pixel SP.

The first control circuit 11 drives the liquid crystal display panel 10. The first control circuit 11 includes a signal processing circuit 11a, a signal output circuit 11b, and a scanning circuit 11c.

The signal processing circuit 11a outputs, to the signal output circuit 11b, sub pixel signals indicating the gradation values of the sub pixels SP based on an image signal transmitted from an external device. The signal processing circuit 11a also outputs, to the signal output circuit 11b and the scanning circuit 11c, a clock signal for synchronizing operation of the signal output circuit 11b and operation of the scanning circuit 11c.

The signal output circuit 11b outputs the sub pixel signals to the sub pixels SP. The signal output circuit 11b is electrically coupled to the sub pixels SP through a plurality of signal lines Lb extending in the D2 direction.

The scanning circuit 11c scans the sub pixels SP in synchronization with the outputting of the sub pixel signals from the signal output circuit 11b. The scanning circuit 11c is electrically coupled to the sub pixels SP through a plurality of scanning lines Lc extending in the D1 direction.

Regions each partitioned by two signal lines Lb adjacent to each other in the D1 direction in plan view and two scanning lines Lc adjacent to each other in the D2 direction, correspond to the sub pixels SP.

The switching element SW is composed of, for example, a thin film transistor (TFT). The switching element SW has a source electrode electrically coupled to the signal lines Lb, and a gate electrode electrically coupled to the scanning lines Lc.

The sub pixel electrode PE is coupled to a drain electrode of the switching element SW. A plurality of the common electrodes CE are disposed corresponding to the scanning lines Lc. The sub pixel electrodes PE and the common electrodes CE each have a light-transmitting property.

The liquid crystal capacitor LC is a capacitance component of a liquid crystal material of a display liquid crystal layer 13 to be described later between the sub pixel electrode PE and the common electrode CE. The storage capacitor CS is disposed between an electrode at the same potential as the common electrode CE and an electrode at the same potential as the sub pixel electrode PE.

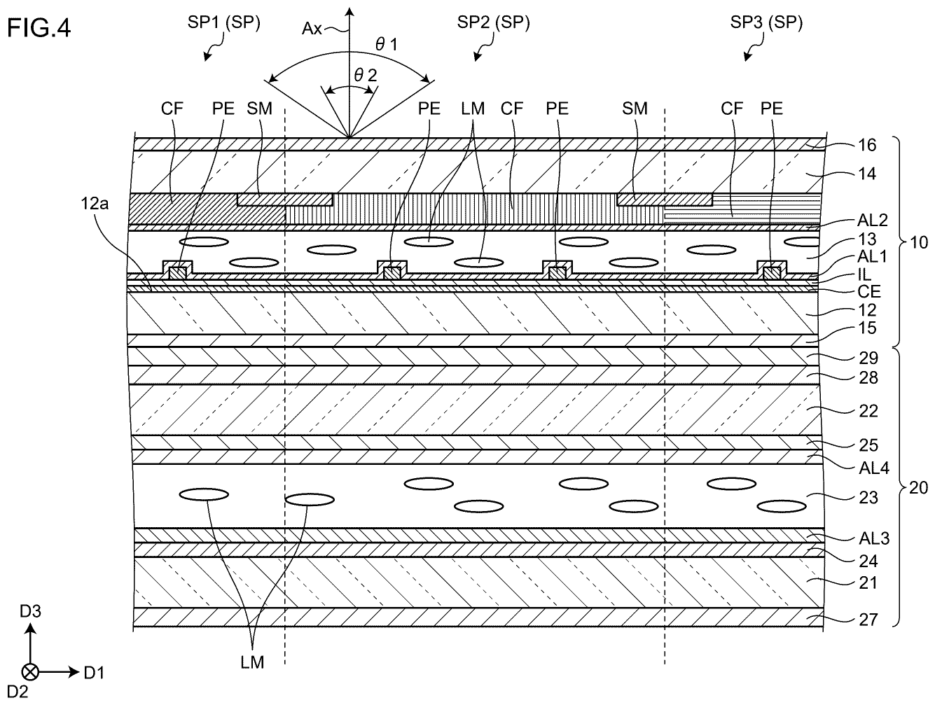

FIG. 4 is a sectional view of the liquid crystal display panel 10 and the viewing angle control panel 20. The liquid crystal display panel 10 further includes a first display substrate 12, the display liquid crystal layer 13, and a second display substrate 14. The first display substrate 12, the display liquid crystal layer 13, and the second display substrate 14 are disposed in the stated order from the negative D3 side toward the positive D3 side in the D3 direction. The first display substrate 12 and the second display substrate 14 have quadrilateral shapes in plan view.

The common electrode CE is disposed on a front surface 12a of the first display substrate 12 on the positive D3 side. An insulating layer IL is disposed on a front surface of the common electrode CE, and in addition, the sub pixel electrode PE and an alignment film ALL are disposed thereon.

The sub pixel electrode PE is disposed between the insulating layer IL and the alignment film AL1. Thus, the common electrode CE and the sub pixel electrode PE are disposed on the first display substrate 12. That is, the liquid crystal display panel 10 is a horizontal electric field type liquid crystal display. The liquid crystal display panel 10 may be driven by an IPS scheme other than the FFS scheme or by a vertical electric field scheme such as a twisted nematic (TN) scheme or a vertical alignment (VA) scheme.

The second display substrate 14 is positioned on the front surface 12a side of the first display substrate 12. Color filters CF, light-shielding films SM, and an alignment film AL2 are disposed on a back surface of the second display substrate 14. The light-shielding films SM and the color filters CF are disposed between the second display substrate 14 and the alignment film AL2.

Each color filter CF has a quadrilateral shape in plan view, and one color filter Cf is disposed for one sub pixel SP. The color filter CF has a light-transmitting property and has a predetermined peak of the spectrum of light to be transmitted. The spectrum peak corresponds to the color of the color filter CF. The color of the color filter CF is the same as the color of the corresponding sub pixel SP. Specifically, a red color filter CF is disposed for the red first sub pixel SP1, a green color filter CF is disposed for the green second sub pixel SP2, and a blue color filter CF is disposed for the blue third sub pixel SP3.

Each light-shielding film SM has a light-shielding property and overlaps the boundary between sub pixels SP adjacent to each other in the D1 or D2 direction in plan view. In other words, the light-shielding films SM overlap the signal lines Lb and the scanning lines Lc in plan view. In FIG. 4, illustrations of the signal lines Lb and the scanning lines Lc are omitted. The signal lines Lb and the scanning lines Lc are disposed on the front surface 12a of the first display substrate 12.

The display liquid crystal layer 13 contains a plurality of liquid crystal molecules LM. The display liquid crystal layer 13 is positioned between the first display substrate 12 and the second display substrate 14 and overlaps the display region DA in plan view. Specifically, the display liquid crystal layer 13 is positioned between the two alignment films AL1 and AL2 facing each other.

As illustrated in FIG. 4, the liquid crystal display panel 10 further includes a first polarization plate 15 disposed on a back surface of the first display substrate 12, and a second polarization plate 16 disposed on a front surface of the second display substrate 14.

The first polarization plate 15 has a transmission axis orthogonal to the D3 direction. The second polarization plate 16 has a transmission axis orthogonal to the transmission axis of the first polarization plate 15 and the D3 direction.

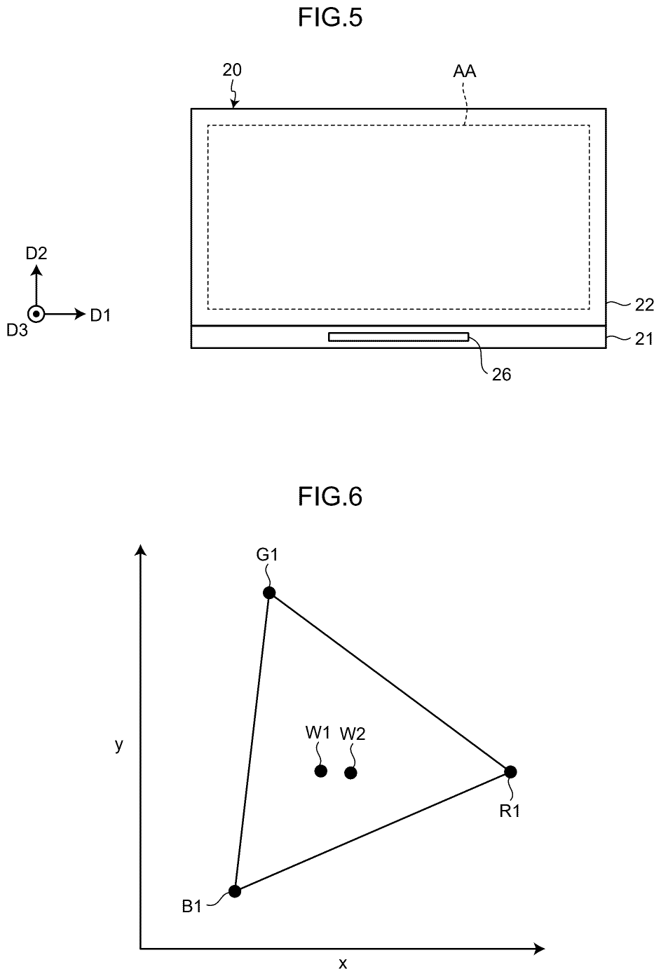

FIG. 5 is a plan view of the viewing angle control panel 20. The viewing angle control panel 20 entirely overlaps the display region DA in plan view. The viewing angle control panel 20 adjusts, in an effective region AA, the viewing angle of the display region DA in the D1 direction. The effective region AA overlaps the display region DA in plan view.

The viewing angle is an angle at which an image displayed in the display region DA can be visually recognized by the persons M1 and M2. The viewing angle is a D1-directional viewing angle, and as illustrated in FIG. 4, expressed by using a D1-directional tilt angle indicating a tilt to both sides in the D1 direction with respect to a reference axis Ax with a reference point as an arbitrary point in the display region DA, wherein the reference axis Ax is an axis along a direction (parallel to the D3 direction in the present embodiment) orthogonal to a principal surface (for example, the front surface) of a substrate included in the viewing angle control panel 20.

In the present embodiment, the viewing angle control panel 20 switches the viewing angle between a first viewing angle θ1 at which an image displayed in the display region DA can be visually recognized by both the person M1 on the driver seat and the person M2 on the front passenger seat and a second viewing angle θ2 at which the image cannot be visually recognized by the person M1 on the driver seat but can be recognized by the person M2 on the front passenger seat (to be described later in detail).

The viewing angle control panel 20 is a liquid crystal panel of a vertical electric field scheme (for example, the TN scheme). The viewing angle control panel 20 includes a first control board 21 (corresponding to a “first substrate”), a second control board 22 (corresponding to a “second substrate”), and a control liquid crystal layer 23 (corresponding to a “liquid crystal layer”) positioned between the first control board 21 and the second control board 22. The first control board 21, the control liquid crystal layer 23, and the second control board 22 are disposed in the stated order from the negative D3 side toward the positive D3 side in the D3 direction.

The first control board 21 is positioned on the back surface side of the second control board 22. An alignment film AL3 and a first electrode 24 are disposed on the front surface side of the first control board 21. The alignment film AL3 contacts the control liquid crystal layer 23. The first electrode 24 has a single-sheet shape and is disposed between the first control board 21 and the alignment film AL3. The first electrode 24 overlaps the effective region AA in plan view.

An alignment film AL4 and a second electrode 25 are disposed on the back surface side of the second control board 22. The alignment film AL4 contacts the control liquid crystal layer 23.

The second electrode 25 is disposed between the second control board 22 and the alignment film AL4. The second electrode 25 is disposed facing the first electrode 24. The second electrode 25 overlaps the effective region AA in plan view.

The first display substrate 12, the second display substrate 14, the first control board 21, and the second control board 22 are made of, for example, glass or resin and have a light-transmitting property. The common electrode CE, the sub pixel electrode PE, the first electrode 24, and the second electrode 25 are made of a conductive material such as indium tin oxide (ITO) or indium zinc oxide (IZO) and have a light-transmitting property. The alignment films AL1, AL2, AL3, and AL4 are horizontal alignment films having alignment regulation force orthogonal to the D3 direction.

The control liquid crystal layer 23 has optical rotatory power that rotates the polarization axis of a polarization component of linearly polarized light as described later. The control liquid crystal layer 23 contains a plurality of liquid crystal molecules LM.

The viewing angle control panel 20 also includes a third polarization plate 27, a fourth polarization plate 28, and a polarization axis rotation element 29. The third polarization plate 27 is disposed on the back surface side of the first control board 21. The fourth polarization plate 28 is disposed on the front surface side of the second control board 22. The polarization axis rotation element 29 is disposed on the front surface side of the fourth polarization plate 28.

The transmission axis of the third polarization plate 27 is orthogonal to the D3 direction. The transmission axis of the fourth polarization plate 28 is orthogonal to the D3 direction and the transmission axis of the third polarization plate 27. The transmission axis of the fourth polarization plate 28 and the transmission axis of the first polarization plate 15 are positioned at different orientations about an axis line along the D3 direction.

The polarization axis rotation element 29 is an optical sheet that rotates the polarization axis of light traveling from the fourth polarization plate 28 toward the liquid crystal display panel 10. Light having passed through the fourth polarization plate 28 has a polarization axis parallel to the transmission axis of the fourth polarization plate 28. The polarization axis rotation element 29 rotates the polarization axis of the light having passed through the fourth polarization plate 28 so that the polarization axis aligns with the transmission axis of the first polarization plate 15.

The polarization axis rotation element 29 may be a single optical sheet or may be multilayered optical sheets. The polarization axis rotation element 29 only needs to exhibit a function to rotate a polarization axis, but is not limited to an optical sheet and may be an element having optical rotatory power, such as a twisted nematic liquid crystal element.

The backlight unit 30 illustrated in FIG. 2 emits light to the liquid crystal display panel 10 through the viewing angle control panel 20. The backlight unit 30 is of an edge type and includes a light source (not illustrated) and a light guiding plate (not illustrated). The light source is, for example, a light emitting diode (LED) or a fluorescent lamp. The light guiding plate guides light emitted from the light source so that the light is incident on the viewing angle control panel 20. The backlight unit 30 may be of a direct type.

The display device 1 does not necessarily need to include the backlight unit 30. In this case, the display device 1 is configured such that the liquid crystal display panel 10 is illuminated with natural light.

In such a display device 1, light emitted from the backlight unit 30 passes through the viewing angle control panel 20 and also the liquid crystal display panel 10. When the first control circuit 11 outputs the above-described sub pixel signals to the sub pixels SP based on an image signal, an electric field is generated in the display liquid crystal layer 13 to change the orientation of the liquid crystal molecules LM of the display liquid crystal layer 13. Accordingly, light passing through the liquid crystal display panel 10 is modulated to display an image in the display region DA.

As illustrated in FIG. 5, the viewing angle control panel 20 further includes a second control circuit 26 (corresponding to a “control circuit”). The second control circuit 26 controls the viewing angle control panel 20 in one of operation modes, namely, a visual recognition mode (corresponding to a “first mode”) in which the image displayed in the display region DA is visually recognized by both the person M1 on the driver seat and the person M2 on the front passenger seat and a non-visual recognition mode (corresponding to a “second mode”) in which the image displayed in the display region DA is not visually recognized by the person M1 on the driver seat but is visually recognized by the person M2 on the front passenger seat.

The second control circuit 26 is disposed on the first control board 21. The second control circuit 26 switches between the visual recognition mode and the non-visual recognition mode based on a switching signal transmitted from the external device. The switching signals include a visual recognition signal for setting the operation mode to the visual recognition mode, and a non-visual recognition signal for setting the operation mode to the non-visual recognition mode.

For example, in a case where a moving image is displayed in the display region DA while the viewing angle control panel 20 operates in the visual recognition mode and the person M2 on the front passenger seat does not want the moving image to be visually recognized by the person M1 on the driver seat while driving, the non-visual recognition signal is transmitted to the second control circuit 26 when the person M2 on the front passenger seat turns on a switch of the external device.

When having received the visual recognition signal, the second control circuit 26 controls the viewing angle control panel 20 in the visual recognition mode. In the visual recognition mode, the second control circuit 26 sets the potential difference between the first electrode 24 and the second electrode 25 of the viewing angle control panel 20 to zero. In this case, no electric field is generated in the control liquid crystal layer 23, and the long axis of the liquid crystal molecules LM in the control liquid crystal layer 23 is orthogonal to the D3 direction.

In this case, the traveling direction of light does not change in the control liquid crystal layer 23. Light having passed through the viewing angle control panel 20 passes through the liquid crystal display panel 10. The viewing angle of the display region DA when the potential difference between the first electrode 24 and the second electrode 25 is zero is referred to as the first viewing angle θ1. When the viewing angle of the display region DA is the first viewing angle θ1, an image in the display region DA can be visually recognized by both the persons M1 and M2.

When having received the non-visual recognition signal, the second control circuit 26 controls the viewing angle control panel 20 in the non-visual recognition mode. In the non-visual recognition mode, the second control circuit 26 outputs voltage that causes a potential difference larger than zero to be generated between the first electrode 24 and the second electrode 25 of the viewing angle control panel 20. In this case (when the potential difference between the first electrode 24 and the second electrode 25 is larger than zero), an electric field is generated in the control liquid crystal layer 23, and the long axis of the liquid crystal molecules LM in the control liquid crystal layer 23 is not orthogonal to the D3 direction but tilts relative to the D3 direction.

When the long axis of the liquid crystal molecules LM in the control liquid crystal layer 23 tilts, light is refracted in accordance with the tilt of the long axis of the liquid crystal molecules LM in the control liquid crystal layer 23. The light refracted in the viewing angle control panel 20 passes through the liquid crystal display panel 10. Accordingly, the viewing angle of the display region DA becomes the second viewing angle θ2.

The second viewing angle θ2 is smaller than the first viewing angle θ1. When the viewing angle of the display region DA becomes the second viewing angle θ2, the person M2 positioned in front of the display device 1 can visually recognize an image displayed in the display region DA, but the person M1 on the driver seat positioned on the negative D1 side of the display device 1 has difficulty in visually recognizing the image displayed in the display region DA.

In this manner, the second control circuit 26 switches the viewing angle of the display region DA by switching between the visual recognition mode and the non-visual recognition mode based on the switching signal transmitted from the external device.

As described above, the person M2 visually recognizes an image in both the visual recognition mode and the non-visual recognition mode. Between the visual recognition mode and the non-visual recognition mode, the degree of tilt of the liquid crystal molecules LM in the control liquid crystal layer 23 is different and the amount of light traveling toward the person M2 is different. Consequently, the hue of an image visually recognized by the person M2 is different between the visual recognition mode and the non-visual recognition mode. The hue difference of the image potentially provides discomfort to the person M2.

Thus, the display device 1 reduces the difference in the hue of an image visually recognized by the person M2 between the visual recognition mode and the non-visual recognition mode. Specifically, in a case where the liquid crystal display panel 10 sets the color of a pixel P to achromatic white, the display device 1 equalizes the chromaticity of the pixel P between when the viewing angle control panel 20 operates in the visual recognition mode and when the viewing angle control panel 20 operates in the non-visual recognition mode.

FIG. 6 is a diagram illustrating the chromaticity of a pixel P in an xy chromaticity diagram of the CIE 1931 color space. The chromaticity of a pixel P is represented by coordinates in the xy chromaticity diagram of the CIE 1931 color space. CIE refers to the International Commission on Illumination (in French, Commission internationale de l'eclairage). Although the letter “e” following the comma (') originally bears a diacritical mark, the character is platform-dependent and thus represented as an alphabetic character “e” in the present specification. The CIE 1931 color space is a color space defined by the International Commission on Illumination in 1931.

In a case where the liquid crystal display panel 10 sets the color of a pixel P to achromatic white, the first control circuit 11 equalizes and maximizes the gradation values of the first sub pixel SP1, the second sub pixel SP2, and the third sub pixel SP3 of the pixel P. Specifically, in a case where gradation data representing the gradation values of the sub pixels SP is 8-bit, the gradation values of the sub pixels SP are represented in 256 levels from 0 (zero) to 255. In other words, the gradation value of each of the first sub pixel SP1, the second sub pixel SP2, and the third sub pixel SP3 of a pixel P when displaying an achromatic white color is 255.

A first white point W1 illustrated in FIG. 6 indicates the chromaticity of a pixel P when displaying a white color in the visual recognition mode. A second white point W2 indicates the chromaticity of the pixel P when displaying a white color in the non-visual recognition mode. The chromaticity of the pixel P is measured by using a colorimeter. The first white point W1 and the second white point W2 are offset from each other in FIG. 6, which indicates difference in the hue of an image visually recognized by the person M2 between the visual recognition mode and the non-visual recognition mode. In the example illustrated in FIG. 6, the second white point W2 is positioned on the positive x side of the first white point W1.

A point R1 indicates the chromaticity of the pixel P when the gradation value of the first sub pixel SP1 is 255, the gradation value of the second sub pixel SP2 is 0, and the gradation value of the third sub pixel SP3 is 0 in the visual recognition mode. Accordingly, the color of the pixel P at the point R1 corresponds to red having the highest saturation in the visual recognition mode. A point G1 indicates the chromaticity of the pixel P when the gradation value of the first sub pixel SP1 is 0, the gradation value of the second sub pixel SP2 is 255, and the gradation value of the third sub pixel SP3 is 0 in the visual recognition mode. Accordingly, the color of the pixel P at the point G1 corresponds to green having the highest saturation in the visual recognition mode. A point B1 indicates the chromaticity of the pixel P when the gradation value of the first sub pixel SP1 is 0, the gradation value of the second sub pixel SP2 is 0, and the gradation value of the third sub pixel SP3 is 255 in the visual recognition mode. Accordingly, the color of the pixel P at the point B1 corresponds to blue having the highest saturation in the visual recognition mode. The color range of the pixel P in the visual recognition mode is an area inside a triangle indicated by solid lines with apexes at the points R1, G1, and B1.

To equalize the chromaticity of a pixel P when displaying a white color between the visual recognition mode and the non-visual recognition mode, at least one of the luminance of the sub pixels SP in the visual recognition mode and the luminance of the sub pixels SP in the non-visual recognition mode is adjusted. For simplification of description, the following describes a case where the luminance of the first sub pixel SP1 is adjusted in the non-visual recognition mode.

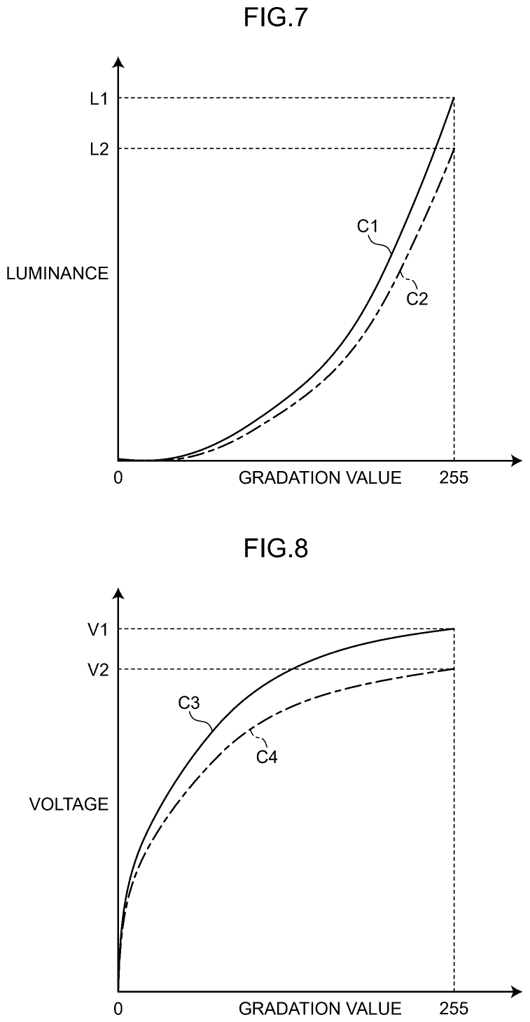

FIG. 7 is a diagram illustrating the relation between the gradation value and luminance of the sub pixel SP.

In a first correlation C1 before the luminance of the sub pixels SP is adjusted in the visual recognition mode and the non-visual recognition mode, the luminance is zero when the gradation value is 0, and the luminance is a first luminance L1 when the gradation value is 255.

To equalize the chromaticity of a pixel P when displaying a white color between the visual recognition mode and the non-visual recognition mode, the luminance of red, in other words, the luminance of the first sub pixel SP1, is decreased so that the second white point W2 illustrated in FIG. 6 is made to be closer to the first white point W1. The luminance of the first sub pixel SP1 when the gradation value of the first sub pixel SP1 is 255 in the non-visual recognition mode is adjusted to a second luminance L2 smaller than the first luminance L1 illustrated in FIG. 7. Thus, the chromaticity of a pixel P when displaying a white color in the visual recognition mode and the chromaticity of a pixel P when displaying a white color in the non-visual recognition mode become the same.

The chromaticity of a pixel P is represented by the values of coordinates (x, y) in the xy chromaticity diagram illustrated in FIG. 6. The chromaticity of a pixel P can be measured by using a photometer. In the present specification, the chromaticity of a pixel P when displaying a white color in the visual recognition mode and the chromaticity of a pixel P when displaying a white color in the non-visual recognition mode are the same when the ratio of the value of the x coordinate at the second white point W2 to the value of the x coordinate at the first white point W1 and the ratio of the value of the y coordinate at the second white point W2 to the value of the y coordinate at the first white point W1 fall within a range of 0.99 to 1.01 (both inclusive). The first white point W1 and the second white point W2 coincide with each other when the ratio of the value of x coordinate and the ratio of the value of the y coordinate are both 1.

In a case where the luminance when the gradation value of the first sub pixel SP1 is 255 in the non-visual recognition mode is adjusted to the second luminance L2 smaller than the first luminance L1, the correlation between the gradation value and luminance of the first sub pixel SP1 becomes a second correlation C2 illustrated in FIG. 7. In the second correlation C2, the luminance is zero when the gradation value is 0, and the luminance is the second luminance L2 when the gradation value is 255.

Thus, in a case where the gradation value of the first sub pixel SP1 is 255, the second luminance L2 of the first sub pixel SP1 in the non-visual recognition mode is lower than the first luminance L1 of the first sub pixel SP1 in the visual recognition mode. Accordingly, in a case where the gradation value of the first sub pixel SP1 is maximum (255) and the gradation values of the second sub pixel SP2 and the third sub pixel SP3 are 0, the luminance of the pixel P when the viewing angle control panel 20 operates in the visual recognition mode is different from the luminance of the pixel P when the viewing angle control panel 20 operates in the non-visual recognition mode.

FIG. 8 is a diagram illustrating the correlation between the gradation value of the sub pixel SP and voltage applied to the sub pixel SP. The voltage applied to the sub pixel SP illustrated in FIG. 8 corresponds to the voltage of a sub pixel signal output from the signal processing circuit 11a. The luminance of the sub pixel SP is adjusted by the voltage applied to the sub pixel SP.

A third correlation C3 illustrated in FIG. 8 corresponds to the first correlation C1 illustrated in FIG. 7. Accordingly, a first voltage V1 corresponds to the first luminance L1. A fourth correlation C4 illustrated in FIG. 8 corresponds to the second correlation C2 illustrated in FIG. 7. Accordingly, a second voltage V2 corresponds to the second luminance L2.

Specifically, in the first sub pixel SP1, the voltage corresponding to the maximum gradation value (255) when the viewing angle control panel 20 operates in the visual recognition mode is different from the voltage corresponding to the maximum gradation value when the viewing angle control panel 20 operates in the non-visual recognition mode.

For simplification of description, the above describes the case where the luminance of the first sub pixel SP1 is adjusted in the non-visual recognition mode to equalize the chromaticity of a pixel P when displaying a white color between the visual recognition mode and the non-visual recognition mode. However, the luminance of at least one sub pixel SP may be adjusted in at least one of the visual recognition mode and the non-visual recognition mode.

For example, the luminance of at least one sub pixel SP may be adjusted in the visual recognition mode. In this case, the first white point W1 is made to be closer to the second white point W2 in FIG. 6. The luminance of at least one sub pixel SP may be adjusted in both the visual recognition mode and the non-visual recognition mode. In this case, the first white point W1 and the second white point W2 each are made to be closer to a chromaticity point different from the first white point W1 and the second white point W2.

Accordingly, in a case where the gradation value of one of a plurality of sub pixels SP is maximum and the gradation values of sub pixels SP other than the one sub pixel SP among the sub pixels SP are 0, the luminance of the pixel P when the viewing angle control panel 20 operates in the visual recognition mode is different from the luminance of the pixel P when the viewing angle control panel 20 operates in the non-visual recognition mode.

In at least one of the sub pixels SP, the voltage corresponding to the maximum gradation value when the viewing angle control panel 20 operates in the visual recognition mode is different from the voltage corresponding to the maximum gradation value when the viewing angle control panel 20 operates in the non-visual recognition mode.

In this manner, the chromaticity of a pixel P when displaying a white color in the visual recognition mode and the chromaticity of a pixel P when displaying a white color in the non-visual recognition mode become the same, so that difference in hue before and after a change in the viewing angle in the display device 1 capable of changing the viewing angle can be reduced. The first control circuit 11 and the second control circuit 26 each include a central processing unit (CPU), a read only memory (ROM), and a random access memory (RAM), an internal storage, an input interface, and an output interface. The CPU, the ROM, the RAM, and the internal storage are coupled with one another through an internal bus. The ROM stores therein programs such as a basic input output system (BIOS). The internal storage is, for example, a hard disk drive (HDD) or a flash memory and stores therein an operating system program and application programs. The CPU executes the programs stored in the ROM and/or programs stored in the internal storage while using the RAM as a work area, thereby providing a variety of functions.

Preferable embodiments of the present invention are described above, but the present invention is not limited to such embodiments. Contents disclosed in the embodiments are merely exemplary, and various kinds of modifications are possible without departing from the scope of the present invention. Any modification performed as appropriate without departing from the scope of the present invention belongs to the technical scope of the present invention. At least one of various kinds of omission, replacement, and modification of any constituent component may be performed without departing from the scope of the above-described embodiments and modifications.

For example, the viewing angle control panel 20 may control the viewing angle in a direction intersecting the D1 direction.

The display device 1 may include two viewing angle control panels 20. In this case, the two viewing angle control panels 20 are stacked in the D3 direction.

The chromaticity of a pixel P may be represented by X, Y, and Z in the XYZ color space of the CIE. In this case, X, Y, and Z of the chromaticity of the pixel P may be acquired by a photometer. X and Z of the CIE may be calculated by using Y, x, and y, of the CIE, which are acquired by a photometer, and Expressions (1) and (2) below.

$$X = Y \times x / y \qquad ( 1 )$$

$$Z = Y \times ( 1 - x - y ) / y \qquad ( 2 )$$

The values of the coordinates of the first white point W1 in FIG. 6 may be calculated from the values of X, Y, and Z of the points R1, G1, and B1. Specifically, the coordinates of the first white point W1 are calculated by using following Expressions (3), (4), (5), (6), and (7), wherein, in the XYZ color space, X, Y, and Z of the point R1 are referred to as Xr, Yr, and Zr; X, Y, and Z of the point G1 are referred to as Xg, Yg, and Zg; and X, Y, and Z of the point B1 are referred to as Xb, Yb, and Zb.

$$Xw = ( Xr + Xg + Xb ) / 3 \qquad ( 3 )$$

$$Yw = ( Yr + Yg + Yb ) / 3 \qquad ( 4 )$$

$$Zw = ( Zr + Zg + Zb ) / 3 \qquad ( 5 )$$

$$xw = Xw / ( Xw + Yw + Zw ) \qquad ( 6 )$$

$$yw = Yw / ( Xw + Yw + Zw ) \qquad ( 7 )$$

In the above, xw in Expression (6) represents the x coordinate of the first white point W1, and yw in Expression (7) represents the y coordinate of the first white point W1. In Expressions (3), (4), (5), (6), and (7), Xw, Yw, and Zw represent X, Y, and Z of the first white point W1 in the XYZ color space. Calculation may be performed in the same manner for the second white point W2.

What is claimed is:

1. A display device comprising:
a liquid crystal display panel including a display region in which a plurality of pixels are arranged;
an electro-optical device overlapping the liquid crystal display panel in plan view; and
a control circuit, wherein
the electro-optical device includes
a first substrate including a first electrode,
a second substrate including a second electrode facing the first electrode, and
a liquid crystal layer positioned between the first electrode and the second electrode,
the control circuit is configured to operate the electro-optical device in one of a first mode in which a potential difference between the first electrode and the second electrode is set to be zero and a second mode in which the potential difference between the first electrode and the second electrode is set to be larger than zero, and
in a case where the liquid crystal display panel displays achromatic white in the pixels, chromaticity of the pixels when the electro-optical device operates in the first mode is equal to chromaticity of the pixels when the electro-optical device operates in the second mode.

2. The display device according to claim 1, wherein
each of the pixels includes a plurality of sub pixels for displaying different colors, and
in a case where a gradation value of one sub pixel among the sub pixels is maximum and gradation values of sub pixels other than the one sub pixel among the sub pixels are zero, a luminance of the pixel when the electro-optical device operates in the first mode is different from a luminance of the pixel when the electro-optical device operates in the second mode.

3. The display device according to claim 1, wherein
each of the pixels includes a plurality of sub pixels for displaying different colors, and
in at least one sub pixel among the sub pixels, a voltage corresponding to a maximum gradation value when the electro-optical device operates in the first mode is different from a voltage corresponding to a maximum gradation value when the electro-optical device operates in the second mode.

4. The display device according to claim 1, wherein chromaticity of each of the pixels is represented by coordinates in an xy chromaticity diagram of the CIE 1931 color space.
